(19) United States
(12) Patent Application Publication
(10) Pub. No.: US 2012/0160574 A1
(43) Pub. Date: Jun. 28, 2012

(54) VEHICLE PASSAGE TREAD SENSOR AND VEHICLE PASSAGE DETECTION APPARATUS

(75) Inventors: Takanobu Nishimura, Kawasaki-shi (JP); Yukio Asari, Yokohama-shi (JP); Akio Yuge, Yokohama-shi (JP)

(73) Assignee: KABUSHIKI KAISHA TOSHIBA, Tokyo (JP)

(21) Appl. No.: 13/408,348

(22) Filed: Feb. 29, 2012

Related U.S. Application Data
(63) Continuation of application No. PCT/JP2010/066691, filed on Sep. 27, 2010.

(30) Foreign Application Priority Data
Sep. 28, 2009 (JP) 2009-221972

(51) Int. Cl. G01G 5/04; G01G 19/02

(52) U.S. Cl. 177/133

(57) ABSTRACT

According to one embodiment, a vehicle passage tread sensor buried in a road in a direction substantially perpendicular to a traveling direction of a vehicle, includes a pipe including a cavity inside and formed of an elastic material, a fluid filling the cavity of the pipe, and a fluid pressure sensor configured to measure a pressure of the fluid.

### CROSS REFERENCE TO RELATED APPLICATIONS

This application is a Continuation Application of PCT Application No. PCT/JP2010/066691, filed Sep. 27, 2010 and based upon and claiming the benefit of priority from prior Japanese Patent Application No. 2009-221972, filed Sep. 28, 2009, the entire contents of which are incorporated herein by reference.

### FIELD

Embodiments described herein relate generally to a vehicle passage tread sensor and a vehicle passage detection apparatus that detect a passing car at a predetermined position of a vehicular traffic route, e.g., a tollgate of a toll road.

### BACKGROUND

In a toll collection system and the like of a toll road, a toll fare often differs depending on each vehicle type such as a large-sized vehicle or a standard-sized vehicle. On the other hand, in recent years, introduction of an ETC [registered trademark] (Electronic Toll Collection) system for unmanned operation of a toll collecting service has been promoted. In the ETC system, vehicle types must be discriminated. In conventional systems, an optical sensor detects a vehicle body, and an axle number detection apparatus set on a road surface detects a tread pressure of tires and determines whether the number of axles is two, three, or above to determine a large-sized vehicle, a standard-sized vehicle, or a smaller vehicle.

Meanwhile, a vehicle usually has four wheels (two pairs of wheels), so that when a pair of wheels passes twice, a vehicle is added. The passage of a pair of wheels will be referred to as passage of an axle here. There is a vehicle in which rear wheels for carrying a very heavy load are constituted of two pairs of wheels. In the case of such a vehicle, the vehicle passes based on three axles.

For example, on a lane at a tollgate of a toll road, an axle passage detection apparatus is installed to cut across the lane, and a vehicle passage tread sensor is set. The vehicle passage tread sensor detects the number of axels to discriminate large-sized vehicles and standard-sized vehicles in vehicles so that a result can be reflected in an automatic toll collection system.

The tread sensor is constituted of conductive rubber and a metal plate electrode. An end portion and a bottom portion of the metal plate electrode are coated with an insulator, and hence the conductive rubber is insulated from the metal plate electrode when no vehicle passes. A fixed voltage is applied to the metal plate electrode. When tires of a vehicle are placed on an upper surface of the tread sensor, the conductive rubber is crushed to bring a conductive rubber electrode and the metal plate electrode into contact with each other, and hence a closed circuit is electrically formed, thereby obtaining an axle passage signal.

However, in such a tread sensor, when the passage of vehicles is repeated, a rubber component such as a plasticizer is extracted from the conductive rubber during a relatively short period. There is a problem that electrical resistance in a contact point increases when the rubber component is deposited on a contact surface of the metal plate electrode, whereby a sensor function is deteriorated.

Further, since a vehicle passes through the tollgate while the brakes are applied, large frictional force functions with respect to the tread sensor, and the tread sensor repeats torsional deformation. As a result, there are problems that the metal plate electrode is deformed to constantly form a closed circuit, or concentration of bending stress occurs at a junction of the metal plate and an electrical cable to disconnect the electrical cable.

There is provided an axel passage detection apparatus including a tread sensor configured in such a manner that air is constantly discharged from a pipe having many blowout openings and detects a change in air pressure at the time of closing the air blowout openings by tires when a vehicle passes, thereby effecting axle passage detection.

However, a passage time of the axle is approximately 10 milliseconds, and an interval between two continuous axles is an interval of approximately 200 milliseconds. Such detection utilizing an instantaneous change in air pressure at the time of passage has a problem of a low SN ratio of a blowout air pressure to noise and responsiveness. Further, since contamination such as clay adhering to tires cannot be removed by blowout of air, there is a problem that the blowout openings are clogged. These are problems concerning detection reliability and performance maintenance of the tread sensor.

Furthermore, vehicle classification is set for expressway tolls, and the vehicle classification is defined based not only on the number of axles but also a total vehicle weight and an inter-axle distance. For example, a microbus belonging to a medium-sized vehicle category is defined with a riding capacity of 11 to 29 people and a total vehicle weight of less than 8 tons. A bus belonging to a large-sized vehicle category is defined as a route bus with a riding capacity of 30 people or more or a total vehicle weight of 8 tons or above, and defined with a total vehicle weight of 8 tons or above, a riding capacity of 29 people or below, and a vehicle length of less than 9 m. Although the vehicle classification is defined based on weights in this manner, conventional tread sensors have a problem that a weight of a passing vehicle cannot be measured.

As described above, the conventional tread sensors have the problem that they do not function as the axle passage detection sensor when the number of times of vehicle passages increases or the problem that the sensor function is lost due to deformation of the metal plate electrode or fracture of the electrical cable upon receiving torsional stress because of frictional force from tires. Moreover, the axle passage detection apparatus disclosed in Patent Literature 1 has the problem of a low SN ratio of a blowout air pressure to noise or responsiveness and also has the problem of clogging of the blowout openings.

### BRIEF DESCRIPTION OF THE DRAWINGS

FIG. 1 is a side view showing a vehicle passage tread sensor according to a first embodiment;

FIG. 2 is a cross-sectional view of a rubber pipe of the vehicle passage tread sensor;

FIG. 3 is a block diagram showing a vehicle passage detection apparatus according to this embodiment;

FIG. 4 is a flowchart showing an operation of the vehicle passage detection apparatus;

FIG. 5 is a view showing a change in fluid pressure at the time of axle passage in the vehicle passage detection apparatus;

FIG. 6 is a view schematically showing a vehicle passage tread sensor according to a second embodiment; and

FIG. 7 is a plan view schematically showing a tollgate where a vehicle passage tread sensor is installed.

### DETAILED DESCRIPTION

In general, according to one embodiment, a vehicle passage tread sensor buried in a road in a direction substantially perpendicular to a traveling direction of a vehicle, comprises: a pipe comprising a cavity inside and formed of an elastic material; a fluid filling the cavity of the pipe; and a fluid pressure sensor configured to measure a pressure of the fluid.

A vehicle passage tread sensor according to a first embodiment will now be described with reference to the drawings.

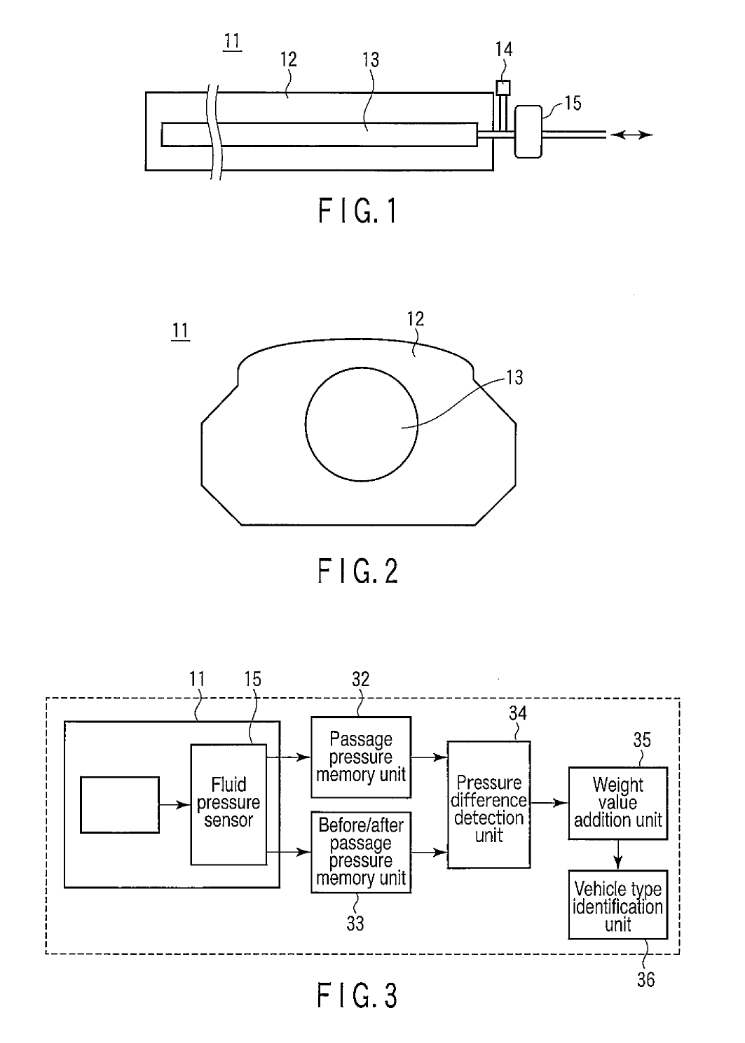

FIG. 1 is a side view of an entire tread sensor according to a first embodiment, and FIG. 2 is a cross-sectional structural view of the tread sensor according to one embodiment of the present invention. Additionally, a vehicle passage tread sensor 11 according to this embodiment is made of an elastic material, e.g., rubber, and it comprises a rubber pipe 12 which has a cavity inside and constitutes a tread, a fluid 13 confined in this cavity, a pressure relief valve 14 as a safety valve which reduces a pressure when a high pressure equal to or above a predetermined pressure is applied to the fluid, and a fluid pressure sensor 15 that detects a pressure applied to the fluid 13. Both ends of the rubber pipe 12 are closed, and the fluid pressure sensor 15 is connected to one end. The fluid pressure sensor 15 measures a pressure of the fluid 13 in the rubber pipe 12 at the time of vehicle passage, converts this change in pressure into an electrical signal, and detects the electrical signal as a pressure value.

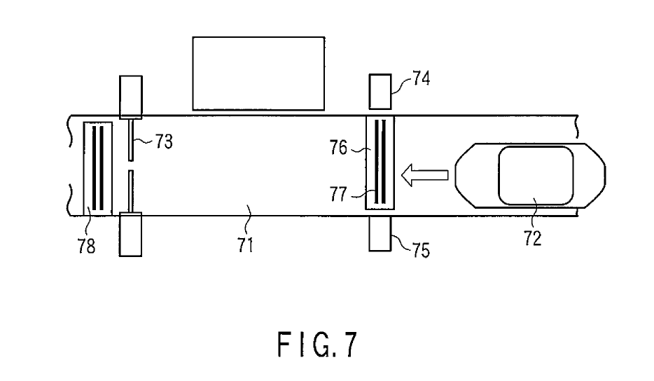

Usually, two such rubber pipes 12 are aligned and buried in a road in parallel as shown in FIG. 7. FIG. 7 is a schematic view showing an example of a tollgate utilizing the vehicle passage tread sensor 11 in a toll road. Reference numeral 71 denotes a lane at the tollgate, and reference numeral 72 designates a vehicle. The vehicle 72 enters from a direction of an arrow in the drawing and passes through a gate 73. An optical sensor light projecting unit 71 and a light receiving unit 75 that sort the number of vehicles are installed to face each other near an entrance of the lane 71 in front of the gate 73.

The vehicle passage detection apparatus 11 is provided at the load below this optical sensor to across the lane of the road, and the two rubber pipes 12 are arranged. The number of axles is detected to classify each vehicle into a large-sized vehicle or a standard-sized vehicle while the optical sensor detects the vehicle, the classification result is reflected in an automatic toll collection system, and the gate 73 is opened. The passage of the vehicle is detected by a vehicle detector 78 set on a road surface near the gate 73, and the gate 73 is closed.

FIG. 3 shows an electrical structural example of a vehicle passage detection apparatus according to this embodiment. This vehicle passage detection apparatus comprises the vehicle passage tread sensor 11, a passage pressure memory unit 32 that stores a pressure at the time of passage detected by the fluid pressure sensor 15 of the vehicle passage tread sensor 11 when an axle of a vehicle passes, a before/after passage memory unit 33 that stores a pressure before or after passage detected by the fluid pressure sensor 15 before or after the axle of a vehicle passes, a pressure difference detection unit 34 that detects a difference between a passage pressure and a before/after passage pressure stored in the passage pressure memory unit 32 and the before/after passage pressure memory unit 33, a weight value addition unit 35 that adds a weight value corresponding to the pressure difference detected by the pressure difference detection unit 34 to obtain a total weight of a vehicle, and a vehicle type identification unit 36 that identifies a vehicle type of a passed vehicle from the total vehicle weight. A pressure electrical signal obtained by the fluid pressure sensor 15 is stored as a pressure value in the passage pressure memory unit 32 and the before/after passage pressure memory unit 33.

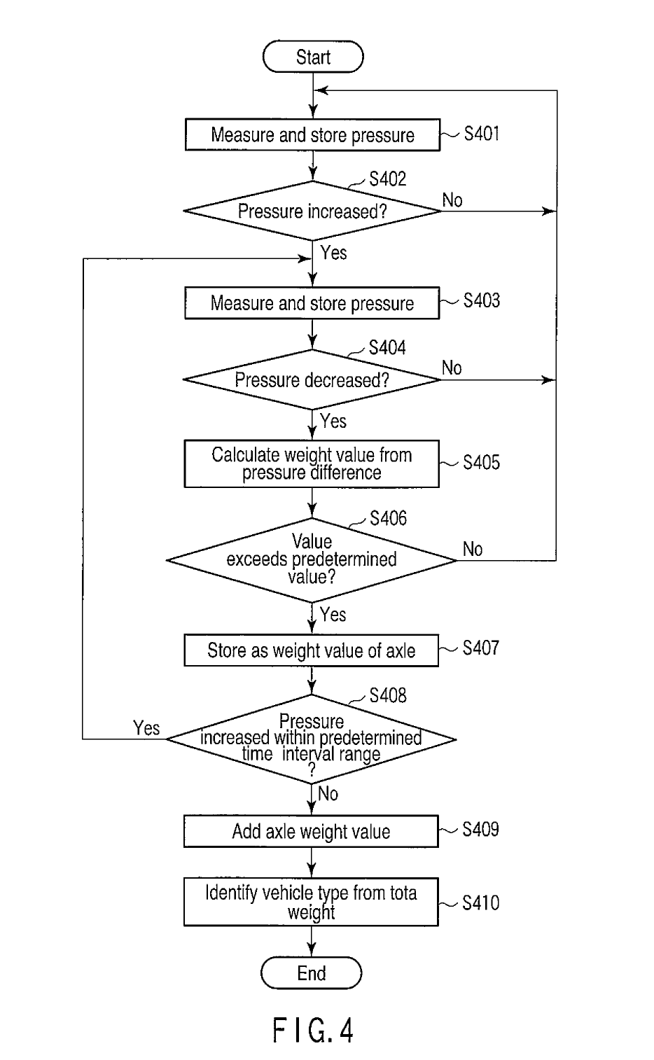

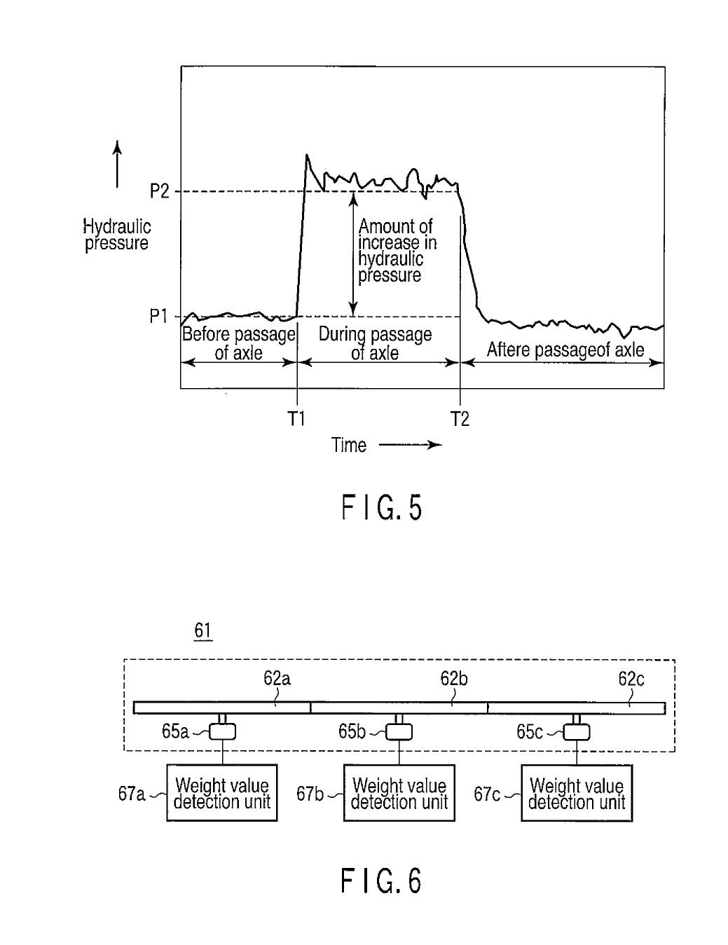

An operation of the vehicle passage detection apparatus according to this embodiment will now be described with reference to FIG. 4 and FIG. 5. FIG. 4 is a flowchart showing an operation of the vehicle passage detection apparatus. FIG. 5 shows a change in fluid pressure with respect to a time when an axle passes through the rubber pipe 12 which is a tread, i.e., before, at the moment, and after the axle moves onto the rubber pipe 12. A change in fluid pressure is detected by the fluid pressure sensor 15. The fact that a pressure fluctuates at any time means that the road is vibrating since vehicles continuously pass.

In FIG. 5, a pressure of the fluid 13 in the rubber pipe 12 is low and a fluid pressure is substantially fixed (P1) from the start to a time T1 corresponding to a time before front wheels (a front axle) get onto the rubber pipe 12 of the vehicle passage tread sensor 11. When fluctuations are large, their average may be obtained.

At a step S401 in FIG. 4, a pressure of the fluid before passage of the axle is first measured by the fluid pressure sensor 15 and stored in the before/after passage pressure memory unit 33.

Then, at a step S402, the fluid pressure sensor 15 detects whether the pressure of the fluid has increased. When the front axle (one pair of front wheels) gets onto the rubber pipe 12 at time T1, the rubber pipe 12 is crushed, and the pressure of the fluid 13 inside is increased to, e.g., P2. When the fluid pressure has increased, this pressure is measured and stored in the passage pressure memory unit 32.

Further, at a time T2 that the front axle passes, the pressure returns to pressure P1, and the fluid pressure sensor 15 detects that the fluid pressure has been reduced at a step S404.

At a step S405, the pressure difference detection unit 34 detects a pressure difference. The pressure difference detection unit 34 acquires a difference between a pressure of the fluid in a state that the rubber pipe is crushed, which is stored in the passage pressure memory unit 32, (a passage pressure) and a pressure of the fluid in a state that the rubber pipe is not crushed, which is stored in the before/after passage pressure memory unit 33, (a before/after passage pressure) and obtains a pressure in a state that the axle is placed on the rubber pipe.

At a step S406, the pressure difference detection unit 34 detects whether this pressure difference exceeds a predetermined value. This detection is carried out since steady noise must be determined when the pressure actually fluctuates but the pressure difference is small. When the pressure difference is equal to or lower than the predetermined value, the processing returns to step S401 to again measure a fluid pressure. When a determination result is NO at each of step S402 and step S404, the processing likewise returns to step S401.

When the pressure difference is larger than the predetermined value at step S406, a weight at the time of passage of the axle is obtained from the pressure difference and stored in the weight value addition unit 35 at a step S407. At a next step S408, whether the fluid pressure increases within a predetermined time interval range is detected. The predetermined time interval range includes a minimum time interval (Tmin) and a maximum time interval (Tmax). This range is provided to check whether a rear axle passes after a front axle of a vehicle passes, and this predetermined time is obtained while considering an interval between a front axle and a rear axle and a vehicle speed of each of the smallest four-wheeled vehicle and the largest four-wheeled vehicle. When the time interval is too short (T<Tmin), it can be considered that a two-wheeled vehicle has entered with a small time lag by coincidence. At step S408, specifically, a determination is made upon whether an interval T from a time point that the pressure first increased to a time point that the pressure again increased falls within the range of Tmin≦T≦Tmax.

When a result is Yes at step S408, the processing returns to step S403 where the increased fluid pressure is measured by the fluid pressure sensor 15 and stored in the passage pressure memory unit 32. At subsequent steps S404 to S407, the same processing as that in the case where the pressure first increased is carried out.

Again at step S408, when the second increase in fluid pressure is finished, the processing usually advances to a step S409 where the front axle weight and the rear axle weight stored in the weight value addition unit 35 as described above are added, and the processing further proceeds to a step S410 where the vehicle type identification unit 36 identifies a vehicle type of the passed vehicle.

It is to be noted that since two rear wheels may be continuous in the large-sized car, Tmin mentioned above may be changed at the second step S408. Alternatively, two time ranges can be determined when the rear axle passes.

It is to be noted that the pressure returns to the same level as that before the passage due to the elasticity of the rubber after the passage of the vehicle. Since the fluid pressure sensor 15 has a pressure-resistance limit value, it is desirable to provide the pressure relief valve 14 to protect the pressure sensor from an excessive pressure.

Here, a shape and a material of the rubber pipe 12, the fluid 13 for filling, and others used in this embodiment will now be described in detail.

If a cross-sectional shape of the rubber pipe 12 corresponds to a shape of, e.g., an aluminum alloy laying case, fixation for laying can be facilitated. The rubber pipe 12 freely deforms even though it receives bending stress from tires of a vehicle passing while braking, and a pressure received from the vehicle is transmitted to the entire pipe as static pressure.

For the material of the rubber pipe 12, abrasion resistance, heat resistance, cold resistance, and fatigue resistance are demanded with respect to use conditions and an environment. Rubber materials generally applied to tires are suitable for this demand. Specifically, a rubber in a natural-rubber (NR) system, a rubber in a styrene-butadiene (SBR) system, a rubber in a polybutadiene (BR) system, a rubber in an isoprene (IR) system, and a rubber in a butyl (IIR) system are rubber materials for tires, and these types of rubber are suitable as the material for the rubber pipe 12.

As the fluid 13 in the rubber pipe 12, both a gas and a liquid can be used. The gas has a merit that it does not inhibit passage of a vehicle when the fluid leaks because of an accident and the like.

On the other hand, in regard to responsiveness of vehicle passage detection, the liquid is preferred. In the case of the liquid, an aqueous liquid is preferred since it does not affect safety of humans, environments, and traffic even though the liquid flows out to a road when the rubber pipe 12 is broken due to an accident and the like. In the case of use in cold climates, as the liquid, an antifreeze liquid used for automobile engines is preferred. In general, 5 to 50% of ethylene glycol is added to water. Such an antifreeze liquid can be used as the fluid that fills the rubber pipe 12.

The rubber pipe 12 must have durability with respect to the fluid 13. It is known that component transfer or a reaction of the fluid and the rubber hardly occurs if a solubility index (an SP value) of the fluid is a numeric value greatly different from that of the rubber material. The SP value of water is 23.4, and the SP value of ethylene glycol is 14.6.

On the other hand, as the SP values of the rubber materials for tires mentioned above, a rubber in the natural-rubber (NR) system has 8.0, a rubber in the styrene-butadiene (SBR) system has 8.6, a rubber in the polybutadiene (BR) system has 8.4, a rubber in the isoprene (IR) system has 8.0, and a rubber in the butyl (IIR) system has 7.8, and combinations using these materials hardly produce reactions since these SP values are greatly different from the SP value of the fluid.

Although the fluid pressure sensor 15 can be classified into a mechanical type and an electronic type, the electronic type that enables high-speed response and has a long life is suitable for the sensor according to this embodiment. In general, there has been widely used a pressure sensor which is of a type having a strain gauge disposed to a stainless diaphragm or a silicon diaphragm. As an example, when the rubber pipe 14 is filled with water under a predetermined hydraulic pressure, the hydraulic pressure fluctuates due to an ambient temperature.

According the fluid pressure sensing type vehicle passage tread sensor and the vehicle passage detection apparatus having the above-described configuration, since this sensor does not adopt an electrode contact system as different from conventional tread sensor, it is possible to avoid the problem of poor contact caused by contamination of an electrode contact point due to extraction of a rubber component, short-circuiting between electrodes due to deformation of a metal plate electrode, or the problem that an electrical wiring cord is deformed and broken due to stress concentration at an end portion of an electrode plate. As a result, the vehicle passage tread sensor that enables stable high-speed response and has a long life can be obtained. Furthermore, according to the above-descried vehicle passage detection apparatus, since a total vehicle weight is measured and a vehicle type is identified by taking a sum of axle weights, the reliability of vehicle classification can be advantageously improved.

It is to be noted that a fluid pressure before passage of an axle is obtained in the foregoing embodiment, but the present invention is not restricted thereto, and a fluid pressure after passage of an axle may be obtained, or fluid pressures before passage of a vehicle and after passage of the axle may be obtained and an average may be subtracted from a fluid pressure at the time of passage of the axle.

A vehicle passage tread sensor according to another embodiment will now be described with reference to FIG. 6. This vehicle passage tread sensor 61 comprises three rubber pipes 62a, 62b, and 62c filled with a fluid and fluid pressure sensors 65a, 65b, and 65c connected to these rubber pipes, respectively like the foregoing embodiment.

The fluid pressure sensors 65a, 65b, and 65c are connected to weight value detection units 67a, 67b, and 67c each of which obtains a pressure difference from an measured fluid pressure difference and a weight value. Therefore, pressures applied to the rubber pipes 62a, 62b, and 62c can be independently measured, and it is possible to separately detect a situation that two two-wheeled motor vehicles (motorcycles) have entered abreast and a situation that a four-wheeled vehicle (a car) has entered. Although the same weight is applied to both left and right wheels in the four-wheeled vehicle, a timing that an axle passes through any one of the fluid pressure sensors 65a, 65b, and 65c and a weight are detected in the case of the two-wheeled motor vehicle. When passage timing differs or when a difference between weights of tires is large, it can be determined that axles are independent.

According to this embodiment, there can be obtained an advantage that parallel running of the two-wheeled motor vehicles and the four-wheeled vehicle can be identified.

### EXAMPLE 1

Specific Example 1 will now be described. In FIG. 1 and FIG. 2, vulcanized natural rubber having hardness of approximately Ha55 to Ha75 was adopted for a rubber pipe 12 of a vehicle passage tread sensor 11. This material has abrasion resistance and elasticity which are on the same level as those of a rubber material that is often used for, e.g., tires of cars. As a fluid 13 in the rubber pipe 12, a 30% ethylene glycol aqueous solution was used. A freezing temperature at this ethylene glycol concentration is approximately −30° C., and the ethylene glycol concentration is adjusted in accordance with a freezing temperature which must be set. It is known that this antifreeze liquid is used as a general radiator liquid for automobiles and it is safe.

A fluid pressure sensor 15 is installed at an end of the vehicle passage tread sensor 11. In this pressure sensor 15, a diaphragm of SUS 630 stainless steel is adopted for a wetted surface for water, and a strain gage is disposed to this diaphragm through an insulating film.

Such a vehicle passage tread sensor 11 was used, and a total weight of a vehicle was measured with an electrical circuit configuration shown in FIG. 3 in accordance with a procedure depicted in FIG. 4 to determine a vehicle type.

That is, as shown in FIG. 4, a fluid pressure before an axle passes the vehicle passage tread sensor 11 is measured. Then, the fluid pressure sensor 15 detects a change in pressure when the axle passes. When a change in pressure before and after the axle passage is calculated and an obtained result is converted into a weight, the weight of the axle can be measured. The measured weights of all axles of the vehicle are totaled to calculate a total weight of the vehicle.

### EXAMPLE 2

An example of a vehicle passage tread sensor in which a rubber pipe is divided into pieces will now be described with reference to FIG. 6. In this vehicle passage tread sensor 61, a configuration that three rubber pipes 62a, 62b, and 62c each having a length of one meter are aligned into a line and constitute one set.

A fluid pipe system filled with a 20% ethylene glycol aqueous solution is adopted for each of the rubber pipes 62a, 62b, and 62c. Fluid pressure sensors 65a, 65b, and 65c are connected to the rubber pipes 62a, 62b, and 62c, respectively. Fluid pressure measurement signals from all the fluid pressure sensors are supplied to weight value detection units 67a, 67b, and 67c, and an axle weight is measured from a pressure difference before and after passage when the passing axle has the same passage time. When the passage time diversifies or when a difference between weights is clear, it is determined that different axles have passed and that two-wheeled motor vehicles have passed abreast.

As described above in detailed, the vehicle passage tread sensor and the vehicle passage detection apparatus including this sensor are characterized in that a pressure at the time of passage of a vehicle is detected using a change in pressure of the confined fluid rather than electrode contact. As a result, an elongated metal plate electrode is not used, and hence a problem of deterioration of an electrical contact surface or deformation of the electrode can be solved. Since the electrode, which can be a factor of deterioration of conduction properties of an electrode contact point, deformation of the electrode, or fracture of a cable junction of the electrode in an electrode contact type tread sensor, is not provided, such problems can be avoided. Since responsiveness of a pressure of the antifreeze aqueous liquid filling the inside of the rubber pipe tread is high, the tread sensor having a high detection accuracy can be obtained. Even if the antifreeze aqueous liquid leaks from the pipe due to an accident and the like, fire or environmental disruption does not occur. This liquid can be also applied in cold climates without freezing up.

Moreover, according to the vehicle passage tread sensor, since an axle weight can be measured based on measurement of a fluctuation in pressure of the fluid at the time of passage of the axle, a total vehicle weight can be measured from a sum total of all axle weights, thereby increasing the probability of vehicle classification.

According to the second embodiment, when the system that the rubber pipes are divided and brought into line is adopted, two-wheeled motor vehicles running abreast can be discriminated from a four-wheeled vehicle.

The present invention is not limited to the foregoing embodiments as it is, and it can be carried out by modifying constituent elements without departing from the scope of the essence of the embodying stage. Additionally, constituent elements disclosed in the foregoing embodiments can be appropriately combined to form various inventions. For example, some constituent elements may be eliminated from all the constituent elements disclosed in the embodiments. Further, constituent elements in different embodiments can be appropriately combined.

A shape, a dimension, a material, and others of each constituent part of the vehicle passage detection apparatus can be changed as required without being restricted to the foregoing embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vehicle passage tread sensor buried in a road in a direction substantially perpendicular to a traveling direction of a vehicle, comprising:
a pipe comprising a cavity inside and formed of an elastic material; a fluid filling the cavity of the pipe; and a fluid pressure sensor configured to measure a pressure of the fluid.

2. The vehicle passage tread sensor according to claim 1, wherein the pipe is formed of a rubber material.

3. The vehicle passage tread sensor according to claim 1, wherein the fluid is a liquid.

4. The vehicle passage tread sensor according to claim 3, wherein the fluid is water or an antifreeze liquid.

5. The vehicle passage tread sensor according to claim 1, wherein the fluid is a gas.

6. The vehicle passage tread sensor according to claim 2, wherein the fluid is a liquid.

7. The vehicle passage tread sensor according to claim 2, wherein the fluid is a gas.

8. A vehicle passage detection apparatus comprising:
a vehicle passage tread sensor which comprises: a pipe comprising a cavity inside and formed of an elastic material; a fluid filling the cavity of the pipe; and a fluid pressure sensor configured to measures a pressure of the fluid, the vehicle passage tread sensor being buried in a road in a direction substantially perpendicular to a traveling direction of a vehicle; and
a pressure difference detection unit configured to measure, when the axle of the vehicle is on the pipe, the fluid pressure at the time of passage of an axle measured by the fluid pressure sensor and the fluid pressure before or after passage of an axle measured by the fluid pressure sensor before or after the axle moves onto the pipe, and detect a weight of the vehicle based on a difference between both the pressures.

9. The apparatus according to claim 8, wherein the pipe is formed of a rubber material.

10. The apparatus according claim 9, wherein the fluid is water or an antifreeze liquid.

11. The apparatus according claim 8, wherein the fluid is water or an antifreeze liquid.
